(19) United States
(12) Patent Application Publication
(10) Pub. No.: US 2015/0234434 A1
(43) Pub. Date: Aug. 20, 2015

(54) TOUCH DISPLAY DEVICE

(71) Applicant: InnoLux Corporation, Miao-Li County (TW)

(72) Inventors: Kuan-Li LIN, Miao-Li County (TW); Chun-Yu WU, Miao-Li County (TW)

(21) Appl. No.: 14/619,647

(22) Filed: Feb. 11, 2015

(30) Foreign Application Priority Data
Feb. 18, 2014 (TW) 103202803

(51) Int. Cl. G06F 1/16; G06F 3/041

(52) U.S. Cl. CPC G06F 1/1656; G06F 3/0412; G06F 1/1643; G06F 2203/04103

(57) ABSTRACT

The present invention provides a new touch display device. The touch display device comprises a touch panel, a display panel, a first frame, a second frame and a back plate. The touch panel is disposed on the display panel. The first frame is disposed adjacent to the display panel and has a first supporting surface supporting the touch panel. The second frame is connected with the first frame and has a second supporting surface supporting the display panel. The display panel is disposed between the back plate and the touch panel, and the back plate is connected with the first frame or the second frame.

### CROSS REFERENCE TO RELATED APPLICATIONS

This Non-provisional application claims priority under 35 U.S.C. §119(a) on Patent Application No(s). 103202803 filed in Taiwan, Republic of China on Feb. 18, 2014, the entire contents of which are hereby incorporated by reference.

### BACKGROUND OF THE INVENTION

1. Field of Invention

The disclosure relates to a touch display device and, in particular, to a touch display device easy for the rework.

2. Related Art

With the progress of technologies, various novel information apparatuses are invented, such as cell phones, tablet computers, ultrabooks and GPS navigation apparatuses. Generally, a keyboard and mouse are commonly used to manipulate the information apparatus for inputting information. Besides, the touch control technology currently also becomes a popular manipulation method for the information apparatus and brings an intuitive operation. Accordingly, a touch display device can provide a friendly and intuitive interface for the input operation, and therefore users of all ages can manipulate the touch device by fingers or a stylus.

An on-cell touch display panel comprises a display panel and a touch panel, and the touch panel comprises a sensing electrode layer and is disposed on the display panel. In the conventional art, an adhesive layer (shaped like “□” for example) is used to attach the touch panel to the display panel. Although the adhesive layer can provide the connection and firmness for the touch panel and the display panel, the whole touch display panel needs to be disassembled when the replacement is required for the damaged touch panel or display panel. Besides, some kind of tool is also required for the replacement, so the whole process becomes complicated. Moreover, because the touch panel and the display panel are really breakable pieces, they will be easily broken during the disassembly and a lot of loss will be thus caused.

Therefore, it is an important subject to provide an innovative touch display device which facilitates the disassembly and reassembly.

### SUMMARY OF THE INVENTION

In view of the foregoing subject, an objective of the disclosure is to provide a touch display device facilitating the rework.

To achieve the above objective, a touch display device according to the invention comprises a touch panel, a display panel, a first frame, a second frame and a back plate. The touch panel is disposed on the display panel. The first frame is disposed adjacent to the display panel and has a first supporting surface supporting the touch panel. The second frame is connected with the first frame and has a second supporting surface supporting the display panel, so that the touch panel and the display are disposed oppositely. The display panel is disposed between the back plate and the touch panel, and the back plate is connected with the first frame or the second frame.

In one embodiment, the second frame comprises a projection, the projection has the second supporting surface and a side surface, and an extension direction of the side surface and the extension direction of the display panel have an included angle, which is less than 90° and greater than 0° and in another embodiment is between 30° and 60°.

In one embodiment, the touch display device further comprises a cushion element disposed between the second supporting surface and the display panel.

In one embodiment, the first frame and the second frame are connected with each other by engaging, locking, adhering or their any combination.

In one embodiment, the first frame or the second frame comprises metal or plastic material.

In one embodiment, the touch display device further comprises a flexible circuit board. The flexible circuit board has a connection region, which is connected to the touch panel and located between the first supporting surface of the first frame and the touch panel.

In one embodiment, the touch display device further comprises a protection element, which accommodates the back plate and connects to a side of the touch panel. The flexible circuit board comprises at least a bent portion, which is disposed between the protection element and the back plate.

In one embodiment, the touch display device further comprises a first protection element and a second protection element, which are connected to each other and accommodate the back plate.

In one embodiment, the first frame comprises an upright portion, and the first protection element is connected to the upright portion.

In one embodiment, a surface of the first protection element and the touch surface of the touch panel are substantially on the same plane.

To achieve the above objective, a touch display device according to the invention comprises a touch panel, a display panel, a first frame, a second frame and a back plate. The touch panel is disposed on the display panel. The first frame is disposed adjacent to the display panel and has a first supporting surface supporting the touch panel. The second frame is connected with the first frame and has a second supporting surface supporting the display panel. The display panel is disposed between the back plate and the touch panel, and a side wall of the back plate overlaps a portion of the second frame and exposes another portion of the second frame.

As mentioned above, in the touch display device of the invention, the first supporting surface of the first frame supports the touch panel and the second supporting surface of the second frame connected with the first frame supports the display panel, so the touch panel and the display panel can be disposed oppositely. Thereby, in comparison with the conventional art, the touch panel and the display panel are supported by the first frame and the second frame, respectively, and an adhesive layer is not used between the touch panel and the display panel, so when the touch panel or display panel malfunctions and needs the rework, the touch panel and the display panel can be easily separated from each other without special tools, and therefore the touch panel and the display panel won't be broken and the loss won't be caused. Accordingly, the touch display device of the invention is advantageous to the easy rework.

### BRIEF DESCRIPTION OF THE DRAWINGS

The disclosure will become more fully understood from the detailed description and accompanying drawings, which are given for illustration only, and thus are not limitative of the present invention, and wherein:

FIG. 1A is a schematic diagram of a part of a touch display device of an embodiment of the invention;

FIG. 1B is a schematic diagram showing the connection between a first frame and a second frame in FIG. 1A; and

FIGS. 2A to 2C are schematic sectional diagrams showing a part of the touch display devices of different embodiments of the invention.

### DETAILED DESCRIPTION OF THE INVENTION

The present invention will be apparent from the following detailed description, which proceeds with reference to the accompanying drawings, wherein the same references relate to the same elements.

To be noted, the embodiments shown in the drawings are just for the illustrative purpose but not for representing the actual dimensions and ratio.

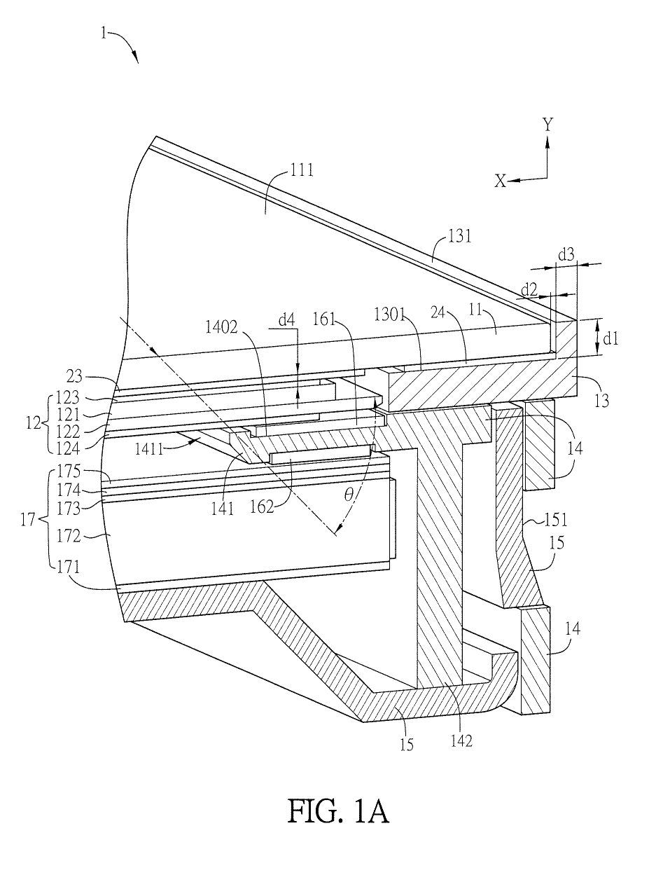

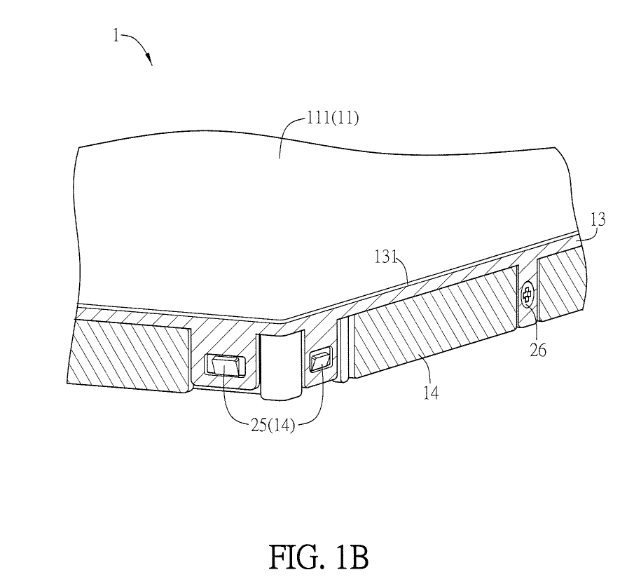

FIG. 1A is a schematic diagram of a part of a touch display device 1 of an embodiment of the invention, and FIG. 1B is a schematic diagram showing the connection between a first frame 13 and a second frame 14 in FIG. 1A. FIG. 1B just shows the touch panel 11, the first frame 13 and the second frame 14 in FIG. 1A, and the other elements of the touch display device 1 are not shown. Moreover, the touch display device 1 is, for example but not limited to, a liquid crystal touch display device or organic light emitting diode (OLED) touch display device with the touch function, or other kinds of touch display devices with the touch function.

The touch display device 1 comprises a touch panel 11, a display panel 12, a first frame 13, a second frame 14 and a back plate 15.

As shown in FIG. 1A, the touch panel 11 and the display panel 12 are disposed oppositely. The touch panel 11 comprises a touch electrode layer (not shown). The touch panel 11 further has a touch surface 111. A horizontal extension direction of the touch surface 111 is defined as a first direction X, and the direction perpendicular to the touch surface 111 is defined as a second direction Y. The first direction X is substantially perpendicular to the second direction Y.

The display panel 12 can be an LCD panel, an OLED display panel or other types of flat display panels. The display panel 12 of this embodiment is an LCD panel for example. The LCD panel (display panel 12) comprises a first substrate 121, a second substrate 122 and at least an optical film. The first substrate 121 and the second substrate 122 are disposed oppositely. A medium layer (not shown) is disposed between the first substrate 121 and the second substrate 122, such as liquid crystal layer or the organic light emitting layer. Each of the first substrate 121, the second substrate 122 and the touch panel 11 can be a glass substrate or a PMMA substrate with high hardness, and therefore the touch display device 1 can be lightened and thinned. In this embodiment, the first substrate 121 is a color filter (CF) substrate while the second substrate 122 is a thin film transistor (TFT) substrate. In other embodiments, however, the black matrix or color filter layer of the CF substrate can be removed to the TFT substrate, so that the second substrate 122 becomes a BOA (BM on array) substrate or a COA (color filter on array) substrate. Besides, the display panel 12 can further comprise a liquid crystal layer (not shown), which is disposed between the first and second substrates 121 and 122.

Herein for example, the display panel 12 comprises two optical films 123, 124. The optical film 123 is an upper polarizer and the optical film 124 is a lower polarizer. The optical film 123 (upper polarizer) is disposed between the first substrate 121 and the touch panel 11, and the optical film 124 (lower polarizer) is disposed on the side of the second substrate 122 away from the first substrate 121. Herein, the optical film 123 is disposed on the upper surface of the first substrate 121 and the optical film 124 is disposed on the lower surface of the second substrate 122. In other embodiments, however, if the display panel 12 is an OLED display panel, the optical film can be removed or just one optical film is included, which is, for example but not limited to, a ¼λ circular polarization sheet or plate, or an anti-reflective film, or their combination, and disposed between the first substrate 121 and the touch panel 11. The touch display device 1 of this embodiment can further comprise a functional film 23, which is disposed between the touch panel 11 and the optical film 123. Herein, the functional film 23 is an anti-scattering film and has an anti-scattering function. The material of the functional film 23 comprises polyethylene terephthalate (PET), triacetyl cellulose (TAC), poly-methylmethacrylate (PMMA) or their any combination for example, but this invention is not limited thereto. Since the functional film 23 is disposed between the touch panel 11 and the display panel 12, even if the touch panel 11 is broken accidentally, the broken glass can be prevented from scattering and damaging other elements of the touch display device 1 or user.

The touch display device 1 of this embodiment can further comprise a backlight module 17, which is disposed opposite the display panel 12 and can emit the light through the display panel 12 so that the display panel 12 can display images. The backlight module 17 comprises, from bottom to top, a reflective sheet 171, a light guiding plate 172 and a plurality of optical films 173, 174, 175. The optical films 173, 174, 175 are, for example but not limited to, light concentration sheets or diffusion sheets. Since the backlight module 17 is not the emphasis in this invention and its disposition and function can be comprehended by those skilled in the art, the description thereof is omitted here for conciseness. When the display panel 12 is an OLED display panel, the backlight module 17 will be omitted because the OLED display panel is a self-luminous panel.

The first frame 13 is disposed adjacent to the display panel 12 and has a first supporting surface 1301. The first frame 13 supports the touch panel 11 by the first supporting surface 1301. In this embodiment, an adhesive element 24 is disposed on the first supporting surface 1301 so that the touch panel 11 is attached to the first supporting surface 1301 and the first frame 13 can supports the touch panel 11. Herein, the adhesive element 24 is, for example but not limited to, a twin adhesive (such as a bezel tape) and used to fix the touch panel 11 on the first frame 13.

The shortest distance dl between the first supporting surface 1301 of the first frame 13 and the touch surface 111 along the second direction Y is between 0.7 mm and 1.9 mm and in another embodiment is 1.5 mm. Moreover, the first frame 13 comprises an upright portion 131, which is connected to the first supporting surface 1301 and disposed adjacent to the touch panel 11. The shortest distance d2 between the upright portion 131 and the touch panel 11 along the first direction X is between 0.15 mm and 0.3 mm and in another embodiment is 0.2 mm. Besides, the width d3 of the upright portion 131 along the first direction X is between 0.6 mm and 1.0 mm and in another embodiment is 0.8 mm. Moreover, the distance d4 between the first substrate 121 and the touch panel 11 along the second direction Y is between 0.25 mm and 0.6 mm and in another embodiment is 0.4 mm.

The second frame 14 is connected with the first frame 13 and has a second supporting surface 1402. The second frame 14 supports the display panel 12 by the second supporting surface 1402 so that the touch panel 11 and the display panel 12 can be disposed oppositely. The first frame 13 and the second frame 14 can be connected with each other by engaging, locking, adhering or their any combination. In this embodiment, as shown in FIG. 1B, the first frame 13 is an upper frame while the second frame 14 is a lower frame, and they are connected with each other by engaging (tenon 25), locking (screw 26), or adhering. Therefore, as long as the locked tenon 25 and the locked screw 26 are disassembled, the first frame 13 and the second frame 14 can be separated from each other. The first or second frame 13 or 14 can include metal or plastic material. For example, the first frame 13/the second frames 14 are plastic frame/plastic frame, plastic frame/metal frame, metal frame/plastic frame or metal frame/metal frame, and this invention is not limited thereto.

As shown in FIG. 1A, the touch display device 1 of this embodiment can further comprise two cushion elements 161, 162, which are disposed and connected to the second frame 14. The second frame 14 comprises a projection 141 and an upright portion 142 connected with the projection 141. The cushion element 161 is disposed on the second supporting surface 1402 and between the projection 141 and the display panel 12. The second frame 14 can hold the display panel 12 through the cushion element 161 and the second supporting surface 1402, and therefore the touch panel 11 and the display panel 12 can be disposed oppositely. The cushion element 162 is disposed between the optical film 175 and the upright portion 142.

The projection 141 of the second frame 14 further has a side surface 1411, in addition to the second supporting surface 1402, and the side surface 1411 is an inclined surface. The extension surface of the side surface 1411 and the display panel 12 have an included angle θ, which is less than 90° and greater than 0°, in another embodiment is between 30° and 60°, and in another embodiment is 45°, but this invention is not limited thereto. The first substrate 121 of this embodiment has a black matrix (not shown) disposed around the edges of the first substrate 121, and the extension surface of the side surface 1411 is connected with the edge of the black matrix near the center of the display panel 12. Thereby, when a user obliquely views the touch surface 111 of the touch panel 11 with the angle θ (such as 45°), a vision line can pass through the edge of the black matrix near the center of the display panel 12 and the user won't see the colored (e.g. black) second frame 14. The side surface 1411 also can be a curved surface or another kind of surface, according to the design requirement.

The back plate 15 can accommodate a touch panel 11, a display panel 12, the first frame 13 or the second frame 14, and the back plate 15 is connected with the first frame 13 or the second frame 14. Herein, the display panel 12 is disposed between the back plate 15 and the touch panel 11. In this embodiment, the back plate 15 supports the display panel 12 and contacts the second frame 14, and the side wall 151 of the back plate 15 overlaps or covers a portion of the second frame 14 and exposes another portion of the second frame 14. In this embodiment, the back plate 15 supports the backlight module 17 and connects to the backlight module 17 and the upright portion 142 of the second frame 14. The second frame 14 can be connected with the back plate 15 by engaging or locking for example.

Accordingly, in the touch display device 1 of the invention, the first supporting surface 1301 of the first frame 13 supports the touch panel 11 and the second supporting surface 1402 of the second frame 14 connected with the first frame 13 supports the display panel 12, so the touch panel 11 and the display panel 12 can be disposed oppositely. Thereby, in comparison with the conventional art, the touch panel 11 and the display panel 12 are supported by the first frame 13 and the second frame 14, respectively, and an adhesive layer is not used to fix the touch panel 11 to the display panel 12, so when the touch panel 11 or the display panel 12 malfunctions and needs the rework, they can be easily separated from each other without special tools, and therefore the touch panel 11 and the display panel 12 won't be broken and the loss won't be caused increasingly.

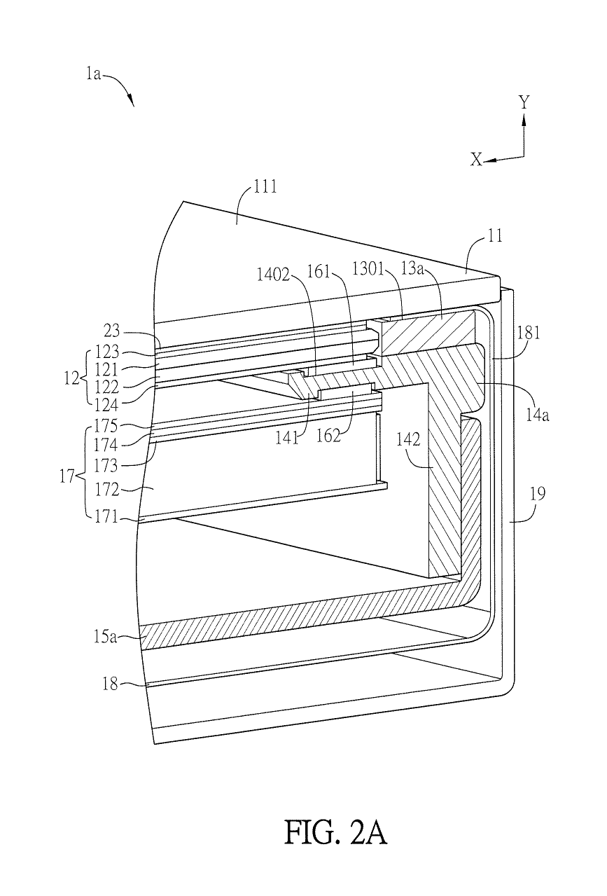

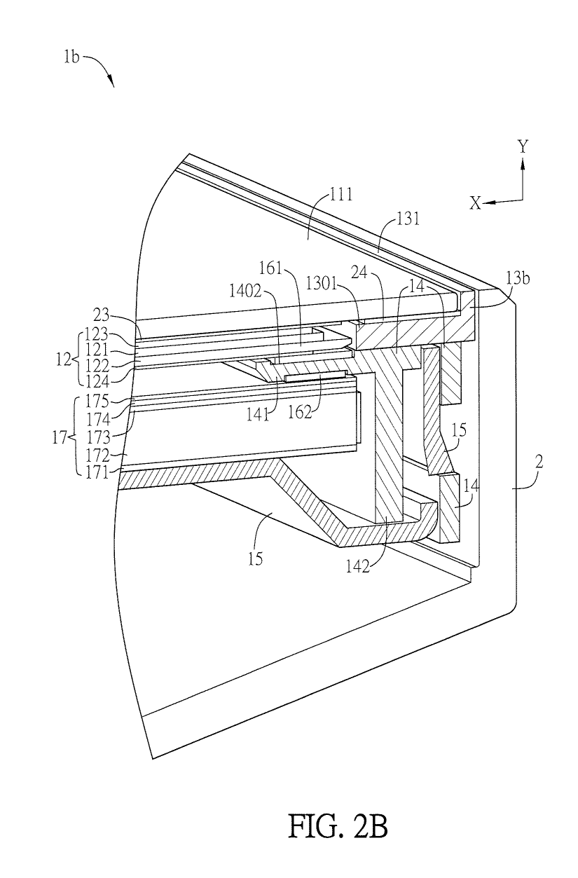

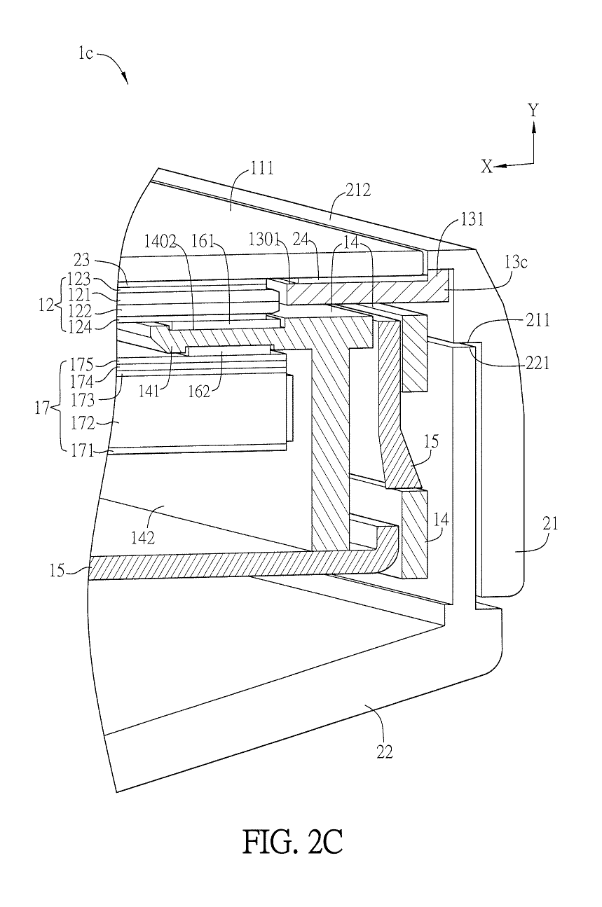

FIGS. 2A to 2C are schematic sectional diagrams showing a part of the touch display devices 1a˜1c of different embodiments of the invention, respectively.

As shown in FIG. 2A, the main difference from the touch display device 1 is that the touch display device la of this embodiment doesn't comprise the adhesive element 24 but can further comprise a flexible circuit board 18 and a protection element 19. The flexible circuit board 18 is bonded to the side of the lower surface of the touch panel 11. The flexible circuit board 18 has a connection region, and the connection region is connected to the touch panel 11 and located between the first supporting surface 1301 of the first frame 13a and the touch panel 11. The flexible circuit board 18 can be a circuit film with COF (chip on film) technology for example so that the touch panel 11 can be electrically connected to a driving circuit board (not shown) that drives the touch panel 11. Since the connection region between the flexible circuit board 18 and the touch panel 11 is located between the first frame 13a and the touch panel 11, the flexible circuit board 18 can be given a support force when it is bent and pulled, so that the structure and function of the flexible circuit board 18 won't be damaged due to the pull force. Moreover, the protection element 19 accommodates the back plate 15a and connects to a side of the touch panel 11. The flexible circuit board 18 comprises at least a bent portion 181, which is disposed among the protection element 19, the first frame 13a, the second frame 14a and the back plate 15a. In one embodiment, the first frame 13a may integrate with the protection element 19, the connection region is located between the protection element 19 and the touch panel 11, and the bent portion 181 is disposed between the protection element 19 and the second frame 14a.

As shown in FIG. 2B, the main difference from the touch display device 1 is that the touch display device 1b of this embodiment can further comprise a protection element 2, which can accommodate the back plate 15 and connects to the upright portion 131 of the first frame 13b. The protection element 2 can protect the inner elements of the touch display device 1b. In one embodiment, the first frame 13b may integrate into the protection element 2.

As shown in FIG. 2C, the main difference from the touch display device 1 is that the touch display device 1c of this embodiment comprises a first protection element 21 and a second protection element 22, which are connected to each other and accommodate the back plate 15. The first protection element 21 comprises a recess 211 and the second protection element 22 comprises a protrusion 221 matched with the recess 211, so that the first protection element 21 and the second protection element 22 can be engaged with each other. Moreover, it can be found, by comparing the touch display device 1c in FIG. 2C with the touch display device lb in FIG. 2B, that the touch display device 1c comprises the first and second protection elements 21 and 22, and the upright portion 131 of the first frame 13c of the touch display device 1c along the second direction Y is lower than the upright portion 131 of the first frame 13 of the touch display device lb, so the first protection element 21 can be connected to the upright portion 131 of the first frame 13c by engaging and therefore a surface 212 of the first protection element 21 and the touch surface 111 of the touch panel 11 are substantially on the same plane. Therefore, the touch display device 1c has a narrower bezel along the first direction X than the touch display device 1b so that the touch display device 1c is more pleasing to the eye.

The technical features of other elements of the touch display devices 1a, 1b, 1c can be comprehended by referring to the same elements of the touch display device 1, and therefore they are not described here for conciseness.

Summarily, in the touch display device of the invention, the first supporting surface of the first frame supports the touch panel and the second supporting surface of the second frame connected with the first frame supports the display panel, so the touch panel and the display panel can be disposed oppositely. Thereby, in comparison with the conventional art, the touch panel and the display panel are supported by the first frame and the second frame, respectively, and an adhesive layer is not used to fix the touch panel to the display panel, so when the touch panel or display panel malfunctions and needs the rework, they can be easily separated from each other without special tools, and therefore the touch panel and the display panel won't be broken and the loss won't be caused increasingly. Accordingly, the touch display device of the invention is advantageous to the easy rework.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch display device, comprising:
a display panel;
a touch panel disposed on the display panel;
a first frame disposed adjacent to the display panel and having a first supporting surface supporting the touch panel;
a second frame connected with the first frame and having a second supporting surface supporting the display panel; and
a back plate, wherein the display panel is disposed between the back plate and the touch panel, and the back plate is connected with the first frame or the second frame.

2. The touch display device as recited in claim 1, wherein the second frame comprises a projection, the projection has the second supporting surface and a side surface, and an extension of the side surface and the display panel have an included angle, which is less than 90° and greater than 0°.

3. The touch display device as recited in claim 1, further comprising:
a cushion element disposed between the second supporting surface and the display panel.

4. The touch display device as recited in claim 1, wherein the first frame and the second frame are connected with each other by engaging, locking, adhering or their any combination.

5. The touch display device as recited in claim 1, wherein the first frame or the second frame comprises metal or plastic material.

6. The touch display device as recited in claim 1, further comprising:
a flexible circuit board having a connection region, which is connected to the touch panel and located between the first supporting surface of the first frame and the touch panel.

7. The touch display device as recited in claim 6, further comprising:
a protection element accommodating the back plate and connecting to a side of the touch panel, wherein the flexible circuit board comprises at least a bent portion, which is disposed between the protection element and the back plate.

8. The touch display device as recited in claim 1, further comprising:
a first protection element and a second protection element, which are connected to each other and accommodate the back plate.

9. The touch display device as recited in claim 8, wherein the first frame comprises an upright portion, and the first protection element is connected to the upright portion.

10. The touch display device as recited in claim 9, wherein a surface of the first protection element and the touch surface of the touch panel are substantially on the same plane.

11. A touch display device, comprising:
a display panel;
a touch panel disposed on the display panel;
a first frame disposed adjacent to the display panel and having a first supporting surface supporting the touch panel;
a second frame connected with the first frame and having a second supporting surface supporting the display panel; and
a back plate, wherein the display panel is disposed between the back plate and the touch panel, and a side wall of the back plate overlaps a portion of the second frame and exposes another portion of the second frame.

12. The touch display device as recited in claim 11, wherein the second frame comprises a projection, the projection has the second supporting surface and a side surface, and an extension of the side surface and the display panel have an included angle, which is less than 90° and greater than 0°.

13. The touch display device as recited in claim 11, further comprising:
a cushion element disposed between the second supporting surface and the display panel.

14. The touch display device as recited in claim 11, wherein the first frame and the second frame are connected with each other by engaging, locking, adhering or their any combination.

15. The touch display device as recited in claim 11, wherein the first frame or the second frame comprises metal or plastic material.

16. The touch display device as recited in claim 11, further comprising:
a flexible circuit board having a connection region, which is connected to the touch panel and located between the first supporting surface of the first frame and the touch panel.

17. The touch display device as recited in claim 16, further comprising:
a protection element accommodating the back plate and connecting to a side of the touch panel, wherein the flexible circuit board comprises at least a bent portion, which is disposed between the protection element and the back plate.

18. The touch display device as recited in claim 1, further comprising:
a first protection element and a second protection element, which are connected to each other and accommodate the back plate.

19. The touch display device as recited in claim 18, wherein the first frame comprises an upright portion, and the first protection element is connected to the upright portion.
